(19) United States
(12) Patent Application Publication
(10) Pub. No.: US 2022/0095143 A1
(43) Pub. Date: Mar. 24, 2022

(54) ANR Configuration, Measurements and Reporting for Power Limited Devices

(71) Applicant: Telefonaktiebolaget LM Ericsson (PUBL), Stockholm (SE)

(72) Inventors: Ritesh Shreevastav, UPPLANDS VÄSBY (SE); Antt Ratilainen, ESPOO (FI); Andreas Höglund, SOLNA (SE); Stefan Engström, LINKÖPING (SE); Magnus Stattin, Upplands Väsby (SE)

(21) Appl. No.: 17/420,844

(22) PCT Filed: Jan. 31, 2020
(86) PCT No.: PCT/EP2020/052381

§ 371 Date: Jul. 6, 2021

Related U.S. Application Data
(60) Provisional application No. 62/799,401, filed on Jan. 31, 2019.

(51) Int. Cl. H04W 24/10; H04W 52/02

(52) U.S. Cl. CPC H04W 24/10; H04W 52/0238

(57) ABSTRACT

According to certain embodiments, a method performed by a User Equipment, UE, comprises receiving, from a network node, at least one parameter for use in performing Automatic Neighbor Relation, ANR, measurements. The method comprises performing one or more measurements while the UE is not connected to the network. The one or more measurements are performed according to the at least one parameter received from the network node. The method comprises determining, based at least in part on the one or more measurements, whether the UE has detected any cells to include in a report. The method comprises transmitting the report to the network node when the UE is connected to the network node.

### BACKGROUND

In Long Term Evolution (LTE) and wideband code division multiple access (WCDMA), the purpose of Automatic Neighbor Relation (ANR) is to identify new neighbour cells (nCells). Once the nCells are identified the knowledge can be used, for example, to enable handovers, for planning and optimization of Physical Cell Identities (PCI), and/or for Random Access Channel configuration and interference co-ordination. Handovers are not supported in narrowband-Internet of Things (NB-IoT). Nonetheless, this feature can be advantageous from a NB-IoT perspective as specified above for Radio Access Network (RAN) internal auto-configuration and optimization and also as input to a cell planner and for optimizing and troubleshooting various eNodeB (eNB) parameters.

Examples of parameters that can be auto-configured or optimized relate to eNB transmission (power, antenna location and tilt), Idle mode mobility (signal quality and strength thresholds), Narrowband frequency signal (NRS) frequency reuse (physical cell identifier based) narrowband-physical broadcast channel (NPBCH), physical downlink shared channel (PDSCH) scheduling information block (SIB1), narrowband primary synchronization signal (NPSS), narrowband secondary synchronization signal (NSSS) intercell interference, Narrowband physical random access channel (NPRACH) detection and false alarm.

In LTE, the ANR procedure can be viewed as two step procedure:
1) receiving unknown PCI in measurement report from UE; and
2) requesting the UE to read and report cell global identity (CGI), tracking area code (TAC), Public Land Mobile Networks (PLMNs) for specified PCI (PCI+SIB1)

Certain challenges may be associated with existing ANR procedures. Currently, it has been agreed in the Third Generation Partnership Project (3GPP) that the NB-IoT user equipment (UE) performs idle mode measurements for ANR, but no further details have been discussed. Performing the measurements and/or reporting as in legacy LTE may cause unnecessary power consumption and battery consumption in the UE, which is especially problematic in the case of NB-IoT UEs because NB-IoT UEs are intended to have long battery life. Also, the existing idle mode measurements may cause issues and/or interfere with Extended Discontinuous Reception (eDRX)/Power Saving Mode (PSM) mechanisms, which may have a negative impact on the UE battery consumption. Additionally, as part of ANR, a UE is supposed to identify the CGI of the strong cell. Performing CGI measurements requires the UE to read the master information block (MIB) and secondary information block (SIB) of the other cell (detected strong cell), which can be power consuming.

### SUMMARY

Solutions to these or other challenges are achieved by the independent claims. Advantageous embodiments are described in the dependent claims.

For example, according to certain embodiments, a method is provided that includes selecting UEs to perform nCell reporting based on the power limitations of the UEs (or in another manner that considers the power limitations of the UEs). UEs are then configured to perform the measurements when not connected to the network. The configuration is made to limit the power consumption by requesting measurements with low-frequency or by limiting the measurements to periods when the UE is already out of sleep mode and/or PSM. The nCells on which the UE is to report are limited by thresholds set by the network. The actual reporting of the nCells is furthermore delayed until the UE is connected to the network anyway. Thus, the reporting may be delayed until the UE is connected to the network for purposes other than for reporting on the nCells.

According to certain embodiments, a method performed by a UE comprises receiving, from a network node, at least one parameter for use in performing ANR measurements. The method comprises performing one or more measurements while the UE is not connected to the network. The one or more measurements are performed according to the at least one parameter received from the network node. The method comprises determining, based at least in part on the one or more measurements, whether the UE has detected any cells to include in a report. The method comprises transmitting the report to the network node when the UE is connected to the network node.

According to certain embodiments, a UE comprises power supply circuitry and processing circuitry. The power supply circuitry is configured to supply power to the UE. The processing circuitry is configured to receive, from a network node, at least one parameter for use in performing ANR measurements. The processing circuitry is configured to perform one or more measurements while the UE is not connected to the network. The one or more measurements are performed according to the at least one parameter received from the network node. The processing circuitry is configured to determine whether the UE has detected any cells to include in a report. The determination is based at least in part on the one or more measurements. The processing circuitry is configuring to transmit the report to the network node when the UE is connected to the network node.

According to certain embodiments, a computer program comprises instructions that, when executed by a UE, causes the UE to perform tasks. The tasks comprise receiving, from a network node, at least one parameter for use in performing ANR measurements. The tasks comprise performing one or more measurements while the UE is not connected to the network. The one or more measurements are performed according to the at least one parameter received from the network node. The tasks comprise determining, based at least in part on the one or more measurements, whether the UE has detected any cells to include in a report. The tasks comprise transmitting the report to the network node when the UE is connected to the network node.

In certain embodiments, the above-described method, UE, and/or computer program may include one or more additional features, such as one or more of the following:

Certain embodiments determine that a cell detected by the UE is a strong cell when at least one measurement value from the cell exceeds a threshold. For example, in certain embodiments, the at least one measurement is performed for a measurement period duration, and the at least one measurement value exceeds the threshold for the measurement period duration. In certain embodiments, the measurement value is an RSRP measurement value, an RSRQ measurement value, or an SINR. In certain embodiments, the threshold comprises an absolute RSRP level.

A detected strong cell is included in a report which could be an ANR report (Automatic Neighbor Relation report). The reported strong cell can be used for determining the power/antenna location or tilt of a eNB radio transmission. It can further be used for Idle mode mobility (signal quality and strength thresholds), Narrowband frequency signal (NRS) frequency reuse (physical cell identifier based) narrowband-physical broadcast channel (NPBCH), physical downlink shared channel (PDSCH) scheduling information block (SIB1), narrowband primary synchronization signal (NPSS), narrowband secondary synchronization signal (NSSS) intercell interference, Narrowband physical random access channel (NPRACH) detection and false alarm.

Certain embodiments include a CGI for the strong cell in the report. Certain embodiments obtain the CGI for the strong cell autonomously. Certain embodiments obtain the CGI for the strong cell in response to determining that a PCI of the strong cell is not included on a black list, the black list indicating cells that are not of interest to the network node.

Certain embodiments store the CGI of the strong cell for a predetermined amount of time. The predetermined amount of time comprises one or more DRX or eDRX cycles for cell reselection.

After detecting the strong cell, certain embodiments switch from an e-DRX cycle to a DRX cycle. The DRX cycle is shorter than the e-DRX cycle, and the CGI is obtained while the wireless device is in the DRX cycle.

In certain embodiments, the at least one parameter is received from the network node via RRC signaling.

In certain embodiments, the at least one parameter comprises any one or more of:
an absolute threshold for a neighboring cell (nCell);
a relative threshold for nCell compared to the serving/camped cell;
an additional offset for nCell relative cell reselection thresholds;
a number of detections of an nCell meeting the threshold;
a time period when nCell detection shall be performed;
special DRX cycles to use when the nCell measurements are performed;
a minimum time period for detection of an nCell meeting the threshold;
a minimum time to keep the nCells in a log;
a minimum number of nCells to keep in the log, once detected;
a latest time when the UE shall report the log to the network node;
time between measurements for nCells;
a value indicating whether nCell measurements shall only be performed when the UE is out of Power Saving Mode, PSM, because of a reason other than performing said measurements;
a value indicating whether nCell measurements shall only be performed when the UE is out of DRX sleep because of a reason other than performing said measurements;
a whitelist of PCIs which are the only ones that shall be logged;
a blacklist of PCIs that shall not be logged;
a value indicating to only log PCI of nCells;
frequencies on which nCell detection shall be performed; and
Public Land Mobile Networks, PLMNs, for which nCells shall be logged.

In certain embodiments, the report transmitted to the network node is empty.

In certain embodiments, the at least one parameter comprises a minimum time period for detection of an nCell meeting a threshold. Thus, certain embodiments determine to include a detected cell in the report based at least in part on a measurement value associated with the detected cell meeting the threshold for at least the minimum time period for detection of the nCell.

In certain embodiments, the at least one parameter comprises a latest time when the UE shall report a log to the network node. Thus, certain embodiments transmit the report to the network node by the latest time when the UE shall report the log to the network node.

In certain embodiments, the at least one parameter comprises a time between measurements for nCells. Thus, certain embodiments perform timing of the measurements based on the time between measurements for nCells parameter.

According to certain embodiments, a method performed by a network node comprises transmitting at least one parameter to a UE. The at least one parameter is for use by the UE in performing ANR measurements when the UE is not connected to the network, the ANR measurements for detecting a strong cell.

According to certain embodiments, a network node comprises power supply circuitry and processing circuitry. The power supply circuitry is configured to supply power to the network node. The processing circuitry is configured to transmit at least one parameter to a UE. The at least one parameter is for use by the UE in performing ANR measurements when the UE is not connected to the network, the ANR measurements for detecting a strong cell.

According to certain embodiments, a computer program comprises instructions that, when executed by a network node, cause the network node to carry out tasks. The tasks comprise transmitting at least one parameter to a UE. The at least one parameter is for use by the UE in performing ANR measurements when the UE is not connected to the network, the ANR measurements for detecting a strong cell.

In certain embodiments, the above-described method, network node, and/or computer program may include one or more additional features, such as one or more of the following:

Certain embodiments configure the UE to detect a PCI of a strong cell in response to performing at least one measurement and determining that at least one measurement value associated with the measurement exceeds a threshold.

Certain embodiments configure the UE to perform the at least one measurement for a measurement period duration and detect the PCI of the strong cell in response to the at least one measurement value exceeding the threshold for the measurement period duration.

In certain embodiments, the measurement value is an RSRP measurement value, an RSRQ measurement value, or an SINR.

Certain embodiments configure the UE to obtain a CGI autonomously.

Certain embodiments transmit a black list of cells to the UE and configure the UE to obtain the CGI for the strong cell in response to determining that the PCI of the strong cell is not included on the black list. The black list indicates cells that are not of interest to the network node.

Certain embodiments configure the UE to store the CGI of the strong cell for a predetermined amount of time. The predetermined amount of time comprises one or more DRX or eDRX cycles for cell reselection.

Certain embodiments configure the UE to, after detecting the PCI of the strong cell, switch from an e-DRX cycle to a DRX cycle, wherein the DRX cycle is shorter than the e-DRX cycle, and wherein the CGI is obtained while the wireless device is in the DRX cycle.

Certain embodiments receive a report indicating the strong cell. For example, certain embodiments receive the report when the UE is connected to the network node.

In certain embodiments, the at least one parameter comprises any one or more of:
an absolute threshold for a neighboring cell (nCell);
a relative threshold for nCell compared to the serving/camped cell;
an additional offset for nCell relative cell reselection thresholds;
a number of detections of an nCell meeting the threshold;
a time period when nCell detection shall be performed;
special DRX cycles to use when the nCell measurements are performed;
a minimum time period for detection of an nCell meeting the threshold;
a minimum time to keep the nCells in a log;
a minimum number of nCells to keep in the log, once detected;
a latest time when the UE shall report the log to the network node;
time between measurements for nCells;
a value indicating whether nCell measurements shall only be performed when the UE is out of Power Saving Mode, PSM, because of a reason other than performing said measurements;
a value indicating whether nCell measurements shall only be performed when the UE is out of DRX sleep because of a reason other than performing said measurements;
a whitelist of PCIs which are the only ones that shall be logged;
a blacklist of PCIs that shall not be logged;
a value indicating whether to only log PCI of nCells;
frequencies on which nCell detection shall be performed; and
Public Land Mobile Networks (PLMNs) for which nCells shall be logged.

In certain embodiments, the at least one parameter is transmitted to the UE via RRC signaling.

In certain embodiments, the report received from the UE is empty.

Certain embodiments configure the UE with a minimum time period for detection of an nCell meeting a threshold.

Certain embodiments configure the UE with a latest time when the UE shall report a log to the network node.

Certain embodiments configure the UE with a time between measurements for nCells.

Certain embodiments may provide one or more of the following technical advantages. For example, one technical advantage may be that certain embodiments make exempt from ANR reporting devices that have severe battery constraints. As another example, another technical advantage may that a UE in idle mode performing the required measurements for ANR will not interfere with eDRX/PSM mechanisms. As such, eDRX/PSM will work as intended to promote longer battery life. As still another example, a technical advantage may be that the UE may not expend battery life to identify the CGI all of the time.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of a UE performing CGI detection at the 4th Cell reselection, in accordance with certain embodiments.

FIG. 2 illustrates an example wireless network, in accordance with certain embodiments.

FIG. 3 illustrates an example user equipment, in accordance with certain embodiments.

FIG. 4 illustrates an example virtualization environment, in accordance with certain embodiments.

FIG. 5 illustrate an example telecommunication network connected via an intermediate network to a host computer, in accordance with certain embodiments.

FIG. 6 illustrates an example host computer communicating via a base station with a user equipment over a partially wireless connection, in accordance with certain embodiments.

FIG. 7 is a flowchart illustrating an example method implemented in a communication system, in accordance with certain embodiments.

FIG. 8 is a flowchart illustrating a second example method implemented in a communication system, in accordance with certain embodiments.

FIG. 9 is a flowchart illustrating a third method implemented in a communication system, in accordance with certain embodiments.

FIG. 10 is a flowchart illustrating a fourth method implemented in a communication system, in accordance with certain embodiments.

FIG. 11 illustrates an example of a method performed by a wireless device, in accordance with certain embodiments.

FIG. 12 illustrates an example schematic block diagram of a virtual apparatus in a wireless network, in accordance with certain embodiments.

FIG. 13 illustrates an example of a method by a network node, in accordance with certain embodiments.

FIG. 14 illustrates an example schematic block diagram of a virtual apparatus in a wireless network, in accordance with certain embodiments.

FIG. 15 illustrates an example of a method performed by a UE, in accordance with certain embodiments.

FIG. 16 illustrates an example of a method performed by a network node, in accordance with certain embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. According to certain embodiments,

In some embodiments, a more general term “network node” may be used and may correspond to any type of radio network node or any network node, which communicates with a UE (directly or via another node) and/or with another network node. Examples of network nodes are NodeB, Master eNB (MeNB), eNB, a network node belonging to master cell group (MCG) or secondary cell group (SCG), base station (BS), multi-standard radio (MSR) radio node such as MSR base station (BS), eNodeB, gNodeB, network controller, radio network controller (RNC), base station controller (BSC), relay, donor node controlling relay, base transceiver station (BTS), access point (AP), transmission points, transmission nodes, remote radio unit (RRU), remote radio head (RRH), nodes in distributed antenna system (DAS), core network node (e.g., mobile switching center (MSC), mobile management entity (MME), etc), OAM, operations and maintenance (O&M), operations support system (OSS), SON, positioning node (e.g., E-Serving Mobile Location Center (E-SMLC)), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UEs are target device, device-to-device (D2D) UE, machine type UE (e.g., MTC UE) or UE capable of machine-to-machine (M2M) communication, personal digital assistant (PDA), pad, tablet, mobile terminals, smart phone, laptop embedded equipped (LEE), laptop mounted equipment (LME), universal serial bus (USB) dongles, UE category M1, UE category M2, Proximity Services (ProSe) UE, vehicle-to-vehicle (V2V) UE, vehicle-to-x (V2X) UE, etc.

The terminologies such as base station/gNodeB and UE should be considered non-limiting and, in particular, do not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

In LTE, ANR is performed during connected mode. As such, the UE detects PCI of a strong cell and reports it via a Measurement Report. Thereafter, the network can configure discontinuous reception (DRX) periods or autonomous gap for the UE. The UE uses the periods with no reception or gap to identify the CGI of the cell (reading MIB and SIB1). More specifically, identifying the CGI implies that the UE needs to read the MIB and SIB information of the detected strong cell. This may be battery consuming. Thus, according to certain embodiments, the network may ensure that UE is not bound to perform the CGI reporting frequently.

As used herein, a cell may be considered a strong cell if, for example, the measured reference signal received power (RSRP) or reference signal received quality (RSRQ) values from that cell exceed a certain threshold value. For example, in a particular embodiment, the threshold may be the RSRP/RSRQ threshold parameters used for cell reselection. The threshold may be an absolute value, in a particular embodiment. In another embodiment, the threshold may be a difference between the serving/camped cell and the strong cell.

According to certain embodiments, in order to save battery in NB-IoT, it is recommended that the UE performs logged measurements during idle mode. As such, there may not be any interaction with the network for CGI discovery. The UE may autonomously decide to obtain the measurements, or the UE may decide to obtain the measurements based upon a white list or a black list of PCI that is configured by the Network.

A white list contains PCI values that the network is interested in and requests the UE to perform ANR measurements upon. By contrast, a black list contains PCI values that the network is not interested in, and thus, a black list informs the UE that on these PCIs the UE should not perform ANR measurements.

At times, the detected strong cell PCI might not be in the white or black list. Or, the list may be unavailable. In such cases, and also even when the UE detected strong cell based upon the list, it may be specified as to when the UE should try to discover the CGI of the cell, according to certain embodiments. There should be a balance between UE power saving and still being able to perform ANR measurements.

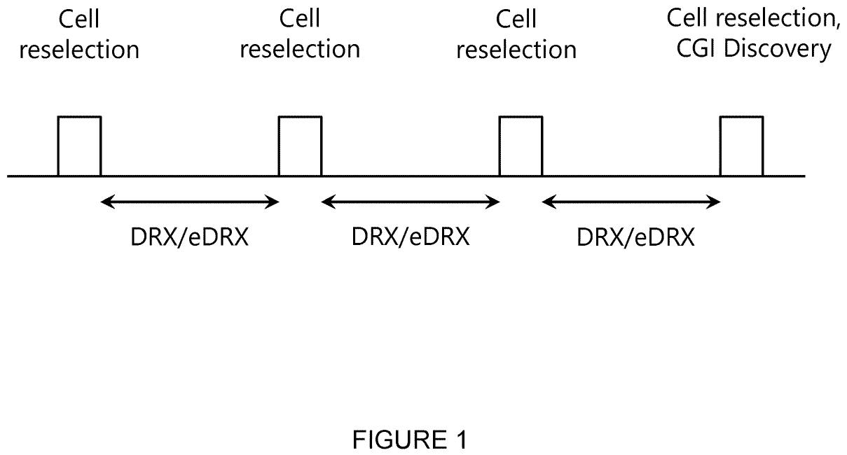

Some example embodiments are provided below to show when the UE may perform the CGI discovery. For example, FIG. 1 illustrates a UE performing CGI detection at the 4^{th} Cell Reselection.

According to certain embodiments, if the UE happens to detect the same strong cell as a cell reselection candidate for a certain count/periodicity, the UE may perform the identification of the CGI and store/log the value. This may be especially useful when the UE is not able to perform the cell reselection to the strong cell such as, for example, when the strong cell is private, an inter-RAT cell, or a barred cell. In these scenarios, the UE may not be able to perform cell reselection. As such, according to certain embodiments, it may be specified as to how long after detecting a strong cell the UE should perform the CGI discovery. These techniques may also be helpful for stationary UEs, which may perform the measurements occasionally and not necessarily perform any mobility related activity such as cell reselection.

An NB-IoT device may be configured with a long eDRX cycle such that the UE may be in sleep mode for approximately 3 hours. According to certain embodiments, however, once the UE has been selected to perform ANR measurements, the UE may skip the long eDRX cycle and switch to normal DRX cycle and perform measurements in idle mode using the intervals defined by normal DRX cycle for intra/inter frequency measurement (cell reselection measurement). In a particular embodiment, the network may specify for how long the UE is required to perform the measurement to identify the strong cell and when the UE is required to perform the CGI discovery. Additionally or alternatively, the network may setup a response time during which the UE is required to report back to the network with the result. In a particular embodiment, the result could be that no PCI detected that was of interest to the network. Thus, the result may be an empty CGI result. After sending the result to the network, the UE may switch back to the long DRX (eDRX) cycle, in a particular embodiment.

An exemplary configuration for the idle mode measurement for ANR that could be specified by radio resource control (RRC) unicast or broadcast signalling and may include a table. 3GPP TS 36.133 V 15.5.0 provides an example of such a table:

| DRX cycle length [s] | [number of DRX cycles] |
|---|---|
| 0.32 | 4 |
| 0.64 | 4 |
| 1.28 | 2 |
| 2.56 | 2 |

The table indicates how many samples the UE should take before concluding that the obtained results are accurate. For example, the first row of the above table indicates that for a DRX cycle length of 0.32 seconds, the UE should take 4 samples spaced at 0.32 seconds. Thus, for each respective DRX cycle length, a UE may be expected to perform ANR measurements after certain DRX cycle.

If the UE happens to perform the cell reselection to the detected strong cell, the UE may record the CGI. In this case, as the cell would be serving cell, no extra battery is consumed to identify the CGI.

According to a particular embodiment, for the strong cell detection, a threshold value may be defined that is an offset to the cell reselection parameters. According to a particular embodiment, a duration may also be specified as to how long or how often the cell should remain a strong cell before confirming it as a strong cell.

An example offset description is provided in the table below. The table is similar to a table from TS 36.304, but two parameters have been added, StrongCellParameter and durationForStrongCellDetection.

Intra-Frequency and Equal Priority Inter-Frequency Cell Reselection Criteria

The cell-ranking criterion Rₛ for serving cell and Rₙ for neighbouring cells is defined by:

$${R}_{s} = {Q}_{m e a s , s} + {Q}_{H y s t} - {Qoffset}_{t e m p} + {Qoffset}_{S C P T M}$$

$${R}_{n} = {Q}_{m e a s , n} - Qoffset - {Qoffset}_{temp} + {Qoffset}_{S C P T M}$$

where:

| | |
|---|---|
| Qₘₑₐₛ | RSRP measurement quantity |
| | used in cell reselections. |
| Qoffset | For intra-frequency: Equals to Qoffset_{s, n}, |
| | if Qoffset_{s, n} is valid, otherwise this equals |
| | to zero. |
| | For inter-frequency: |
| | Except for NB-IoT, equals to Qoffset_{s, n} plus |
| | Qoffset_{frequency}, if Qoffset_{s, n} is valid, |
| | otherwise this equals to Qoffset_{frequency}. |
| | For NB-IoT equals to Qoffset Dedicated_{frequency} |
| | for any frequency other than the frequency of the |
| | dedicated frequency offset, if |
| | QoffsetDedicated_{frequency} is valid, |
| | otherwise this equals to Qoffset_{frequency} (if |
| | QoffsetDedicated_{frequency} is valid Qoffset_{frequency} |
| | is not used). |
| Qoffsetₜₑₘₚ | Offset temporarily applied to a cell as specified |
| | in [3] |
| Qoffset_{SCPTM} | Offset temporarily applied to a Single-Cell Point- |
| | To-Multipoint (SC-PTM) frequency as specified |
| | below. The offset is applied to all cells on the |
| | SC-PTM frequency. If Qoffset_{SCPTM} is valid, |
| | Qoffset for inter-frequency neighbour cells is |
| | not used. |
| StrongCellParameter | Threshold for detecting strong cell |
| durationForStrongCell | Time duration as how long the cell would be |
| Detection | required to be considered as strong cell. |
| | This could be based upon several cell |
| | reselection durations. If UE finds a cell to |
| | have signal > StrongCellParameter for n |
| | consecutive cell reselection count, UE can assume |
| | that the cell is strong cell. Upon which the UE |
| | shall read the CGI of the cell. |
| | If UEs serving cell fulfils that criteria, then |
| | UE will log it after this duration. |

Rn is ranking for neighbor cell. For a strong cell detection, the comparison could be done such that the Rn/Rs>X; where X is configurable, according to certain embodiments.

A strong signal parameter could also be configured such that, if Rn>StrongCelllparameter, strong cell detection criteria is met, according to certain embodiments.

As reports from only certain population of UE in a cell is adequate for ANR rather than all the UEs in the cell, the filtering of which UE to select would be done using the battery indication from the UE. Accordingly, according to certain embodiments, an eNB may select the NB-IoT devices/UE for ANR reporting based upon the battery indication. The following table provides an example of a battery indication from 3GPP TS 23.682 Version 15.5.0, section 5.10.1.

TABLE 5
CP parameters

| | |
|---|---|
| Battery indication | Identifies power consumption criticality for the UE: |
| | if the UE is battery powered with not rechargeable/not |
| | replaceable battery, battery powered with rechargeable/ |
| | replaceable battery, or not battery powered. |
| | [optional] |

According to certain embodiments, the duration between identification of strong cell and the discovery of the CGI may be specified. For stationary devices, this parameter may not be present. An example sequence for the UE for ANR for this case/embodiment is presented below:
determining strong cells first based on the configured threshold/offset and after that performing the actual ANR measurements on the selected strong
during the actual ANR measurements, acquiring the target strong cell's MIB/SIB to get CGI; and
identifying PCI of the target cell and acquiring CGI from that PCI should not be too separated in time to ensure there is no PCI confusion/mismatch.

According to certain embodiments, the network may select a set of one or more UEs to perform ANR where at first stage ANR for NB-IoT is limited to only logging of the PCI of the cell. For example, the UE may only log the PCI of the cells and may report the PCIs to the network. The network (O&M) may do the post-processing of the PCI results and select a second set of one or more UEs to perform the CGI detection of those PCIs of interest. The selected UEs in the second set may be different than the initial selection of the set of UEs to perform ANR, in a particular embodiment.

In a particular embodiment, the second set of UEs may receive the information to perform the CGI detection and may not further record any new PCI cell for ANR (strong cell detection) but only verify if they can detect the PCI for which CGI is needed. The network may setup a response time during which the UE is required to report back to the network with the result, in a particular embodiment. The result could also be an empty CGI result if no PCI was detected that was of interest to the network. In a particular embodiment, detection of PCI may imply detection of strong cell as per the definition above (threshold above with an offset compared to cell reselection requirements).

As summary, parameters that can be given by the network to the UE to specify the CGI reading, logging and reporting may include in certain embodiments:
absolute threshold for nCell
relative threshold for nCell compared to the serving/camped cell
additional offset for nCell relative cell reselection thresholds
number of detections of an nCell meeting the threshold
time period when nCell detection shall be performed
special DRX cycles to use when the nCell measurements are performed
minimum time period for detection of an nCell meeting the threshold
minimum time to keep the nCells in the log
minimum number of nCells to keep in the log, once detected
the latest time when the UE shall report the log to the network,
time between measurements for nCells
nCell measurements shall only be performed when anyway not in PSM=yes/no
nCell measurements shall only be performed when anyway not in DRX sleep=yes/no
whitelist of PCIs which are the only ones that shall be logged
blacklist of PCIs that shall not be logged
only log PCI of nCells (not CGI, PLMNs etc)=yes/no
frequencies on which nCell detection shall be performed
PLMNs for which nCells shall be logged
Method of measurements: Immediate, deferred
Method of measurement reporting (Early Data Transmission (EDT), or transmission in connected mode)

The quantity for the threshold could be, for example, RSRP, RSRQ, Signal to Interference and Noise Ratio (SINR), or a combination thereof.

The parameter values can be set from an operation and maintenance (O&M) system, internally by the node itself or by another network function.

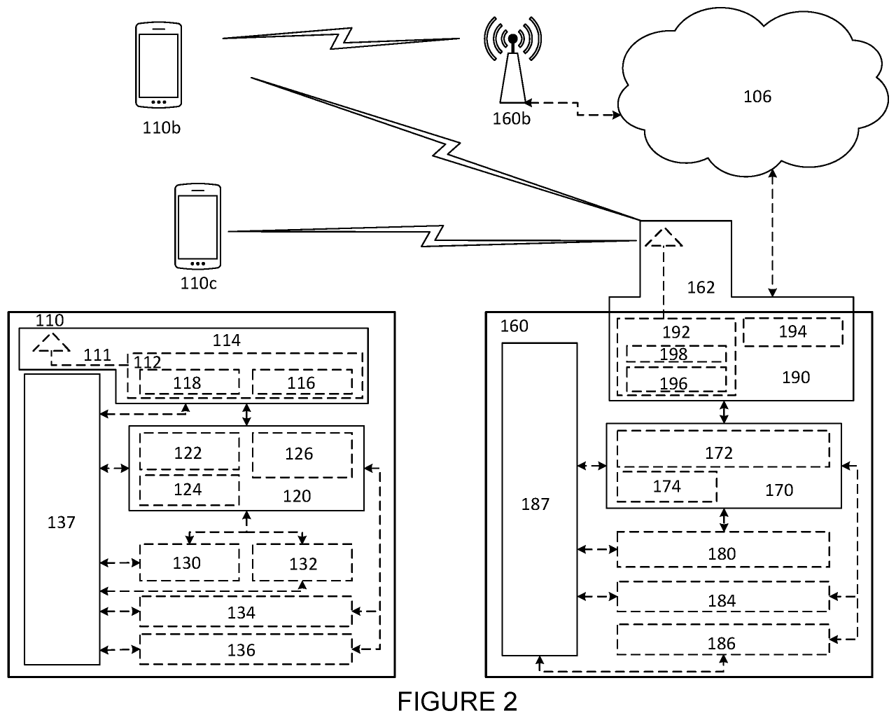

FIG. 2 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 2. For simplicity, the wireless network of FIG. 2 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 2, network node 160 includes processing circuitry 170, device readable medium 180, interface 190, auxiliary equipment 184, power source 186, power circuitry 187, and antenna 162. Although network node 160 illustrated in the example wireless network of FIG. 2 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 2 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

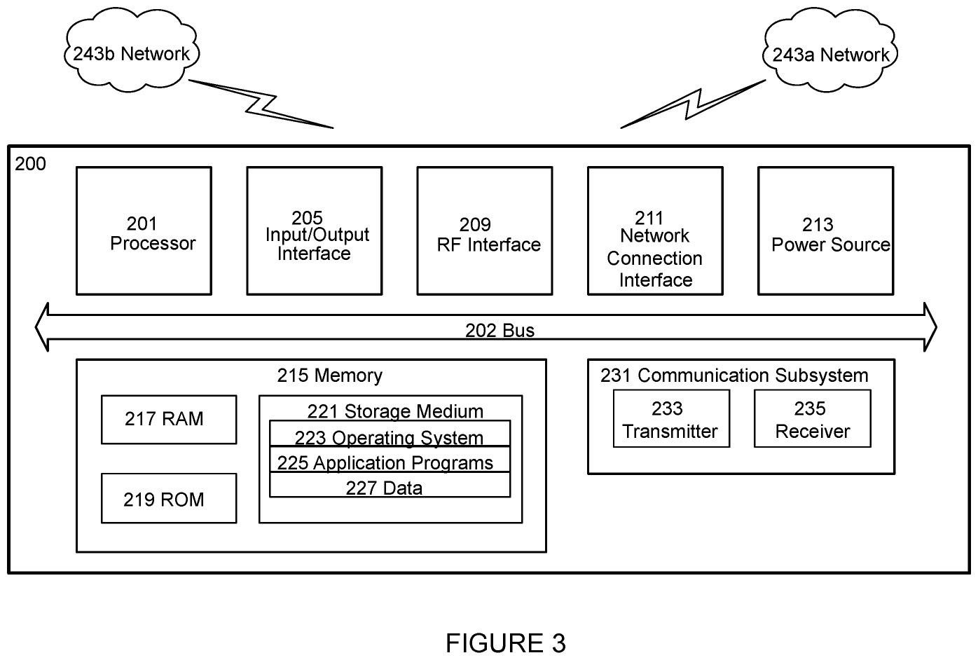

FIG. 3 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 3, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 3 is a UE, the components discussed herein are equally applicable to a WD, and vice-versa.

In FIG. 3, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 3, or only a subset of the components. The level of integration between the components may vary from one UE to another UE. Further, certain UEs may contain multiple instances of a component, such as multiple processors, memories, transceivers, transmitters, receivers, etc.

In FIG. 3, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 3, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 3, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

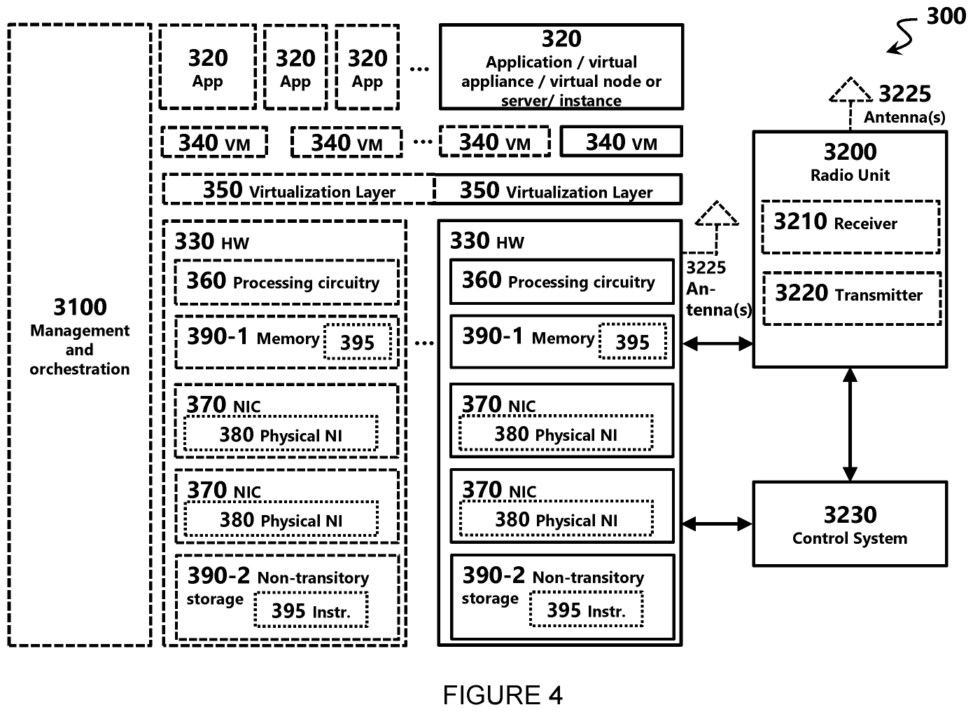

FIG. 4 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 4, hardware 330 may be a standalone network node with generic or specific components. Hardware 330 may comprise antenna 3225 and may implement some functions via virtualization. Alternatively, hardware 330 may be part of a larger cluster of hardware (e.g., such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 4.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

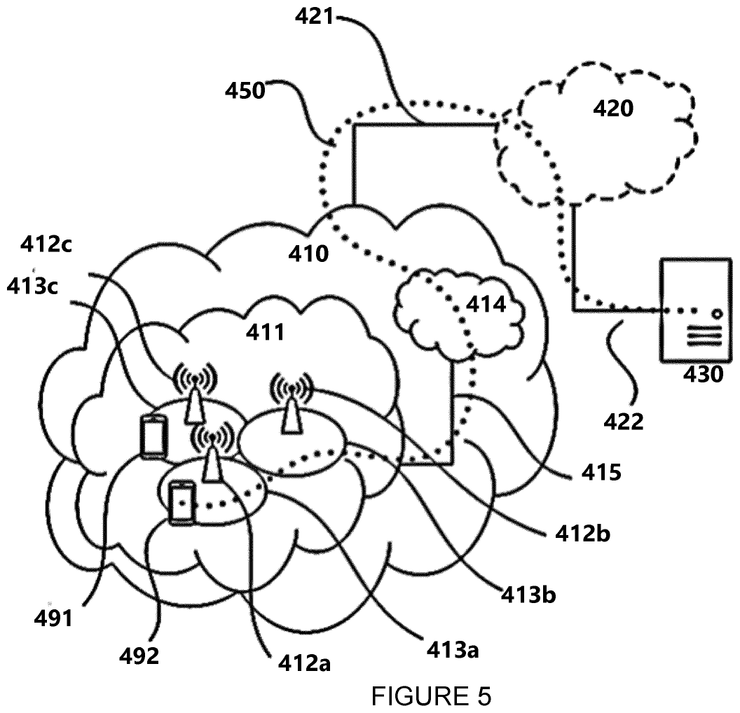

FIG. 5 illustrates a telecommunication network connected via an intermediate network to a host computer in accordance with some embodiments.

With reference to FIG. 5, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 5 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

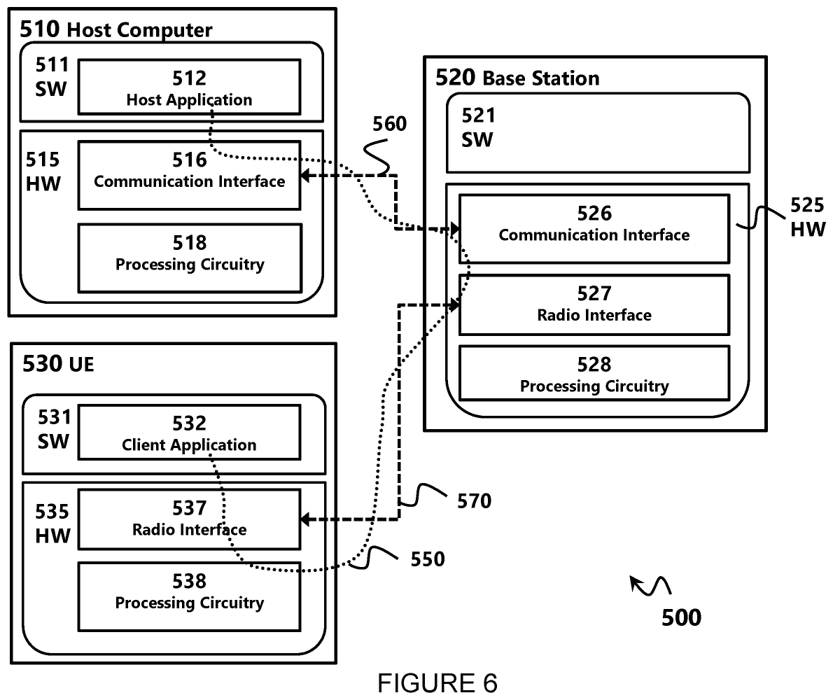

FIG. 6 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 6. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 6) served by base station 520. Communication interface 526 may be configured to facilitate connection 560 to host computer 510. Connection 560 may be direct or it may pass through a core network (not shown in FIG. 6) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 6 may be similar or identical to host computer 430, one of base stations 412a, 412b, 412c and one of UEs 491, 492 of FIG. 5, respectively. This is to say, the inner workings of these entities may be as shown in FIG. 6 and independently, the surrounding network topology may be that of FIG. 5.

In FIG. 6, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

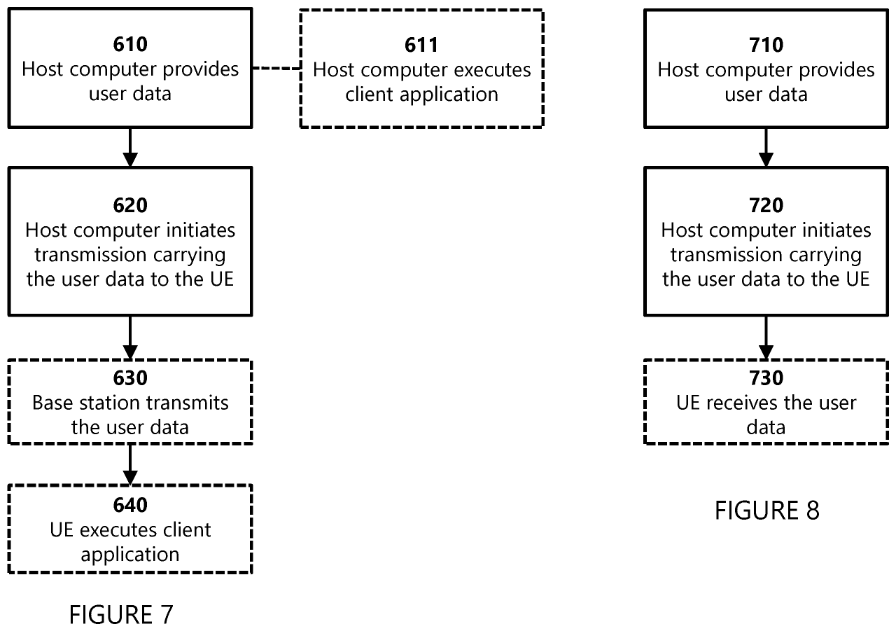

FIG. 7 is a flowchart illustrating a method implemented in a communication system, in accordance with one embodiment. The communication system includes a host computer, a base station and a UE which may be those described with reference to FIGS. 5 and 6. For simplicity of the present disclosure, only drawing references to FIG. 7 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 8 is a flowchart illustrating a method implemented in a communication system, in accordance with one embodiment. The communication system includes a host computer, a base station and a UE which may be those described with reference to FIGS. 5 and 6. For simplicity of the present disclosure, only drawing references to FIG. 8 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

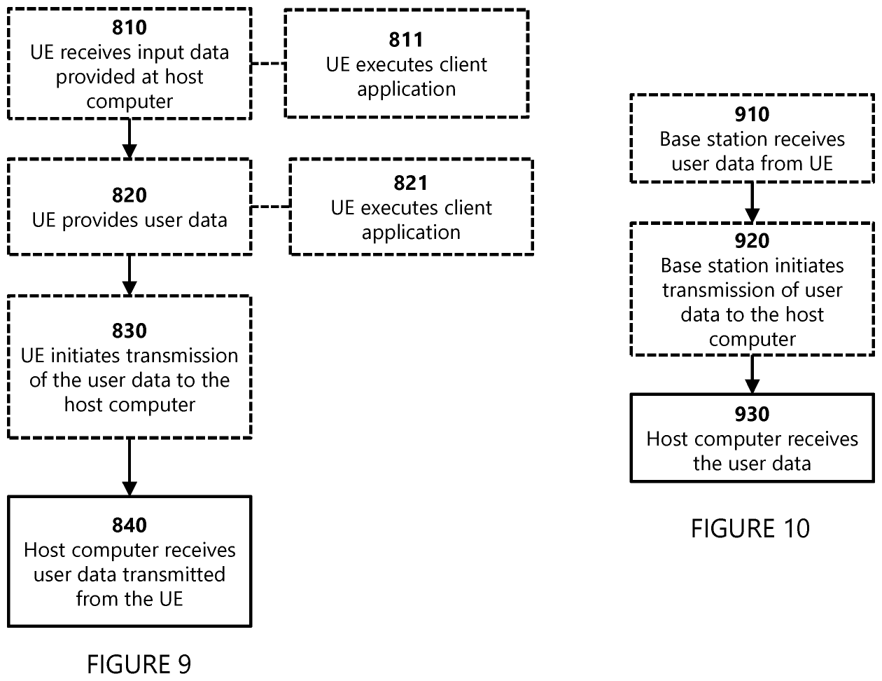

FIG. 9 is a flowchart illustrating a method implemented in a communication system, in accordance with one embodiment. The communication system includes a host computer, a base station and a UE which may be those described with reference to FIGS. 5 and 6. For simplicity of the present disclosure, only drawing references to FIG. 9 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in sub step 830 (which may be optional), transmission of the user data to the host computer. In step 840 of the method, the host computer receives the user data transmitted from the UE, in accordance with the teachings of the embodiments described throughout this disclosure.

FIG. 10 is a flowchart illustrating a method implemented in a communication system, in accordance with one embodiment. The communication system includes a host computer, a base station and a UE which may be those described with reference to FIGS. 5 and 6. For simplicity of the present disclosure, only drawing references to FIG. 10 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

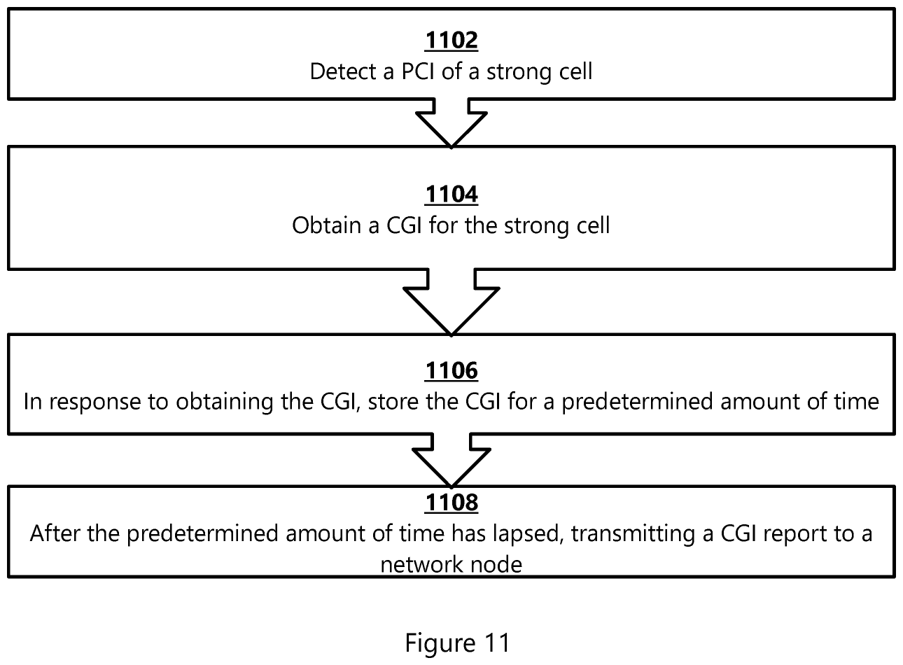

FIG. 11 depicts a method by a wireless device, such as wireless device 110 or UE 200 described above, according to certain embodiments. At step 1102, the wireless device detects a PCI of a strong cell. At step 1104, the wireless device obtains a CGI for the strong cell. In response to obtaining the CGI, the wireless device stores the CGI for a predetermined amount of time, at step 1106. After the predetermined amount of time has lapsed, the wireless device transmits a CGI report to a network node, at step 1108.

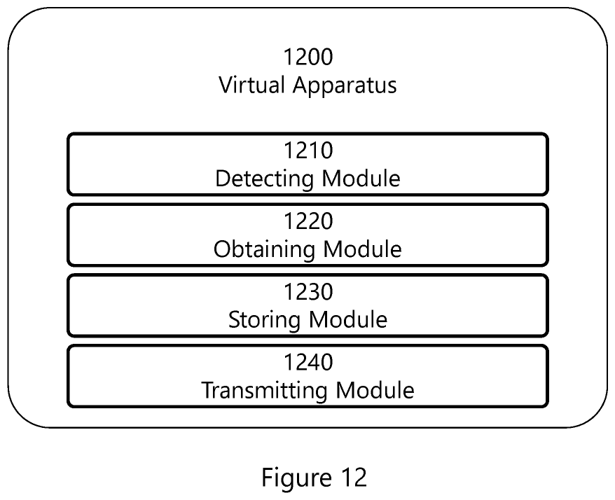

FIG. 12 illustrates a schematic block diagram of a virtual apparatus 1200 in a wireless network (for example, the wireless network shown in FIG. 2). The apparatus may be implemented in a wireless device or network node (e.g., wireless device 110 or network node 160 shown in FIG. 2). Apparatus 1200 is operable to carry out the example method described with reference to FIG. 11 and possibly any other processes or methods disclosed herein. It is also to be understood that the method of FIG. 11 is not necessarily carried out solely by apparatus 1200. At least some operations of the method can be performed by one or more other entities.

Virtual Apparatus 1200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause detecting module 1210, obtaining module 1220, storing module 1230, transmitting module 1240, and any other suitable units of apparatus 1200 to perform corresponding functions according one or more embodiments of the present disclosure.

According to certain embodiments, detecting module 1210 may perform certain of the detecting functions of the apparatus 1200. For example, detecting module 1210 may detect a PCI of a strong cell.

According to certain embodiments, obtaining module 1220 may perform certain of the obtaining functions of the apparatus 1200. For example, obtaining module 1220 may obtain a CGI for the strong cell.

According to certain embodiments, storing module 1230 may perform certain of the storing functions of the apparatus 1200. For example, storing module 1230 may, in response to obtaining the CGI, store the CGI for a predetermined amount of time.

According to certain embodiments, transmitting module 1240 may perform certain of the transmitting functions of the apparatus 1200. For example, transmitting module 1240 may transmit a CGI report to a network node after the predetermined amount of time has lapsed.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

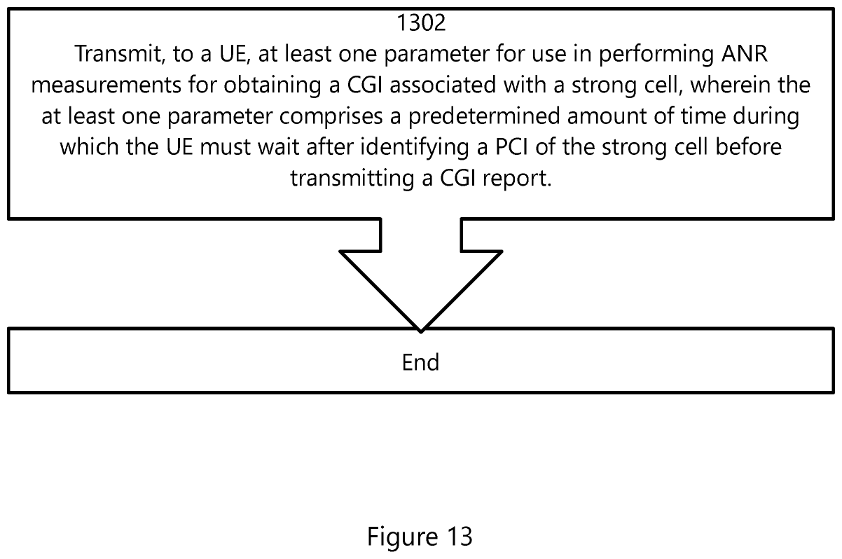

FIG. 13 depicts a method by a network node, according to certain embodiments. At step 1302, the network node may transmit, to a UE, at least one parameter for use in performing ANR measurements for obtaining a CGI associated with a strong cell. The at least one parameter may include a predetermined amount of time during which the UE must wait after identifying a PCI of the strong cell before transmitting a CGI report.

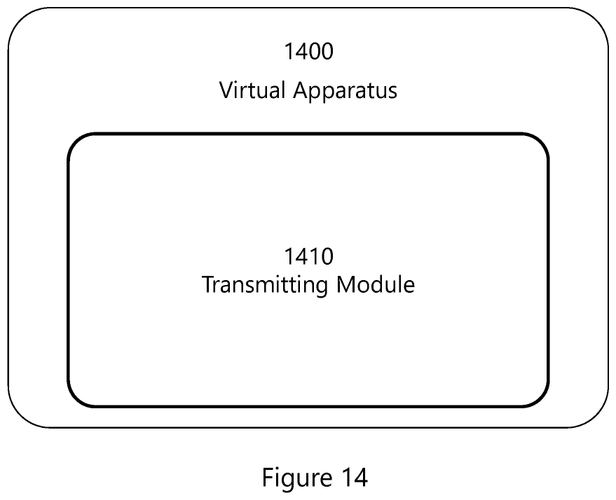

FIG. 14 illustrates a schematic block diagram of a virtual apparatus 1400 in a wireless network (for example, the wireless network shown in FIG. 2). The apparatus may be implemented in a wireless device or network node (e.g., wireless device 110 or network node 160 shown in FIG. 2). Apparatus 1400 is operable to carry out the example method described with reference to FIG. 13 and possibly any other processes or methods disclosed herein. It is also to be understood that the method of FIG. 14 is not necessarily carried out solely by apparatus 1400. At least some operations of the method can be performed by one or more other entities.

Virtual Apparatus 1400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1410 and any other suitable units of apparatus 1400 to perform corresponding functions according one or more embodiments of the present disclosure.

According to certain embodiments, transmitting module 1410 may perform certain of the transmitting functions of the apparatus 1400. For example, transmitting module 1410 may transmit, to a UE, at least one parameter for use in performing ANR measurements for obtaining a CGI associated with a strong cell. The at least one parameter may include a predetermined amount of time during which the UE must wait after identifying a PCI of the strong cell before transmitting a CGI report.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### EXAMPLE EMBODIMENTS

### Group A Embodiments

1. A method performed by a UE, the method comprising:
   detecting a PCI of a strong cell;
   obtaining a CGI for the strong cell;
   in response to obtaining the CGI, storing the CGI for a predetermined amount of time;
   after the predetermined amount of time has lapsed, transmitting, to a network node, a CGI report.
2. The method of Embodiment 1, wherein the PCI of the strong cell is detected in response to performing at least one measurement and determining that at least one measurement value associated with the measurement exceeds a threshold used for cell reselection.
3. The method of Embodiment 2, wherein the at least one measurement is performed for a measurement period duration, and the PCI of the strong cell is detected in response to the at least one measurement value exceeding the threshold for the measurement period duration.
4. The method of any one of Embodiments 2 to 3, wherein the measurement value is a reference signal received power measurement value or a reference signal received quality measurement value.
5. The method of any one of Embodiments 2 to 4, wherein the at least one measurement is performed while the UE is in idle mode or power-saving mode.
6. The method of any one of Embodiments 2 to 5, wherein the threshold comprises an offset associated with a cell reselection parameter.
7. The method of any one of Embodiments 1 to 6, wherein obtaining the CGI for the strong cell comprises reading at least one of a master information block and a secondary information block of the strong cell.
8. The method of any one of Embodiments 1 to 7, wherein the UE obtains the CGI autonomously.
9. The method of any one of Embodiments 1 to 8, wherein the UE obtains the CGI in response to determining that the PCI of the strong cell is included on a list of cells of which the network node is interested.
10. The method of any one of Embodiments 1 to 8, wherein the UE obtains the CGI in response to determining that the PCI of the strong cell is not included on a list of cells of which the network node is interested.
11. The method of any one of Embodiments 1 to 10, further comprising: prior to detecting the PCI of the strong cell, receiving information indicating the predetermined amount of time from the network node.
12. The method of any one of Embodiments 1 to 11, wherein the predetermined amount of time comprises one or more DRX or eDRX cycles for cell reselection.
13. The method of any one of Embodiments 1 to 11, wherein the predetermined amount of time comprises a plurality of DRX or eDRX cycles for cell reselection.
14. The method of any one of Embodiments 1 to 13, wherein the predetermined amount of time comprises a response time after which the UE is required to report the CGI to the network node.
15. The method of any one of Embodiments 1 to 14, further comprising after detecting the PCI of the strong cell, switching from an e-DRX cycle to a DRX cycle, wherein the DRX cycle is shorter than the e-DRX cycle, and wherein the CGI is obtained while the wireless device is in the DRX cycle.
16. The method of any one of Embodiments 1 to 15, wherein the CGI report comprises the CGI of the strong cell.
17. The method of any one of Embodiments 1 to 15, further comprising that the strong cell is not of interest to the network node, and wherein the CGI report does not include the CGI of the strong cell.
18. The method of any one of Embodiments 1 to 17, wherein obtaining the CGI for the strong cell comprises waiting a predetermined number of DRX cycle lengths prior to obtaining the CGI for the strong cell.
19. The method of any one of Embodiments 1 to 18, wherein the UE is in a set of wireless devices selected to perform ANR measurements.
20. The method of Embodiment 19, wherein the UE is selected to be in the set of UEs based on a battery life indication of the UE being greater than a threshold battery life value.
21. The method of any one of Embodiments 1 to 20, wherein the predetermined amount of time is zero when the UE is stationary.
22. The method of any one of Embodiments 1 to 21, further comprising receiving at least one parameter from the network node, and using the at least one parameter while obtaining the CGI.
23. The method of Embodiment 22, wherein the at least one parameter comprises any one or more of:
   an absolute threshold for a neighboring cell (nCell);
   a relative threshold for nCell compared to the serving/camped cell;
   an additional offset for nCell relative cell reselection thresholds;
   a number of detections of an nCell meeting the threshold;
   a time period when nCell detection shall be performed;
   special DRX cycles to use when the nCell measurements are performed;
   a minimum time period for detection of an nCell meeting the threshold;
   a minimum time to keep the nCells in a log;
   a minimum number of nCells to keep in the log, once detected;
   a latest time when the UE shall report the log to the network node;
   time between measurements for nCells;
   nCell measurements shall only be performed when anyway not in PSM=yes/no;
   nCell measurements shall only be performed when anyway not in DRX sleep=yes/no;
   a whitelist of PCIs which are the only ones that shall be logged;
   a blacklist of PCIs that shall not be logged;
   only log PCI of nCells (not CGI, PLMNs etc)=yes/no;
   frequencies on which nCell detection shall be performed; and
   PLMNs for which nCells shall be logged.

### Group B Embodiments

24. A method performed by a base station, the method comprising:
   transmitting, to a UE, at least one parameter for use in performing ANR measurements for obtaining a CGI associated with a strong cell, wherein the at least one parameter comprises a predetermined amount of time during which the UE must wait after identifying a PCI of the strong cell before transmitting a CGI report.
25. The method of Embodiment 24, further comprising configuring the UE to detect the PCI of the strong cell in response to performing at least one measurement and determining that at least one measurement value associated with the measurement exceeds a threshold used for cell reselection.
26. The method of Embodiment 25, further comprising configuring the UE to perform the at least one measurement for a measurement period duration and detect the PCI of the strong cell in response to the at least one measurement value exceeding the threshold for the measurement period duration.
27. The method of any one of Embodiments 25 to 26, wherein the measurement value is a reference signal received power measurement value or a reference signal received quality measurement value.
28. The method of any one of Embodiments 25 to 27, further comprising configuring the UE to perform the at least one measurement while the UE is in idle mode or power-saving mode.
29. The method of any one of Embodiments 25 to 28, wherein the threshold comprises an offset associated with a cell reselection parameter.
30. The method of any one of Embodiments 24 to 29, further comprising configuring the UE to obtain a CGI for the strong cell by reading at least one of a master information block and a secondary information block of the strong cell.
31. The method of any one of Embodiments 24 to 30, further comprising configuring the UE to obtain the CGI autonomously.
32. The method of any one of Embodiments 24 to 30 further comprising: transmitting a list of cells of which the base station is interested to the UE and configuring the UE to obtain the CGI in response to determining that the PCI of the strong cell is included on the list of cells of which the base station is interested.
33. The method of any one of Embodiments 24 to 30, further comprising: transmitting a list of cell of which the base station is not interested and configuring the UE to obtain the CGI for the strong cell in response to determining that the PCI of the strong cell is not included on the list.
34. The method of any one of Embodiments 24 to 33, wherein the predetermined amount of time comprises one or more DRX or eDRX cycles for cell reselection.
35. The method of any one of Embodiments 24 to 33, wherein the predetermined amount of time comprises a plurality of DRX or eDRX cycles for cell reselection.
36. The method of any one of Embodiments 24 to 35, wherein the predetermined amount of time comprises a response time after which the UE is required to report a CGI for the strong cell to the base station.
37. The method of any one of Embodiments 24 to 36, further comprising configuring the UE to, after detecting the PCI of the strong cell, switch from an e-DRX cycle to a DRX cycle, wherein the DRX cycle is shorter than the e-DRX cycle, and wherein the CGI is obtained while the wireless device is in the DRX cycle.
38. The method of any one of Embodiments 24 to 37, further comprising receiving a CGI report after the predetermined amount of time, wherein the CGI report comprises the CGI of the strong cell.
39. The method of any one of Embodiments 24 to 37, further comprising receiving a CGI report after the predetermined amount of time, wherein the CGI report does not include the CGI of the strong cell.
40. The method of any one of Embodiments 24 to 39, wherein the predetermined amount of time comprises a predetermined number of DRX cycle lengths the UE must wait before obtaining the CGI for the strong cell.
41. The method of any one of Embodiments 24 to 40, further comprising selecting a set of UEs to perform ANR measurements, the UE being in the set of selected UEs.
42. The method of Embodiment 41, wherein the UE is selected to be in the set of UEs based on a battery life indication of the UE being greater than a threshold battery life value.
43. The method of any one of Embodiments 24 to 42, wherein the predetermined amount of time is zero when the UE is stationary.
44. The method of any one of Embodiments 24 to 43, wherein the at least one parameter comprises any one or more of:
   an absolute threshold for a neighboring cell (nCell);
   a relative threshold for nCell compared to the serving/camped cell;
   an additional offset for nCell relative cell reselection thresholds;
   a number of detections of an nCell meeting the threshold;
   a time period when nCell detection shall be performed;
   special DRX cycles to use when the nCell measurements are performed;
   a minimum time period for detection of an nCell meeting the threshold;
   a minimum time to keep the nCells in a log;
   a minimum number of nCells to keep in the log, once detected;
   a latest time when the UE shall report the log to the network node;
   time between measurements for nCells;
   nCell measurements shall only be performed when anyway not in PSM=yes/no;
   nCell measurements shall only be performed when anyway not in DRX sleep=yes/no;
   a whitelist of PCIs which are the only ones that shall be logged;
   a blacklist of PCIs that shall not be logged;
   only log PCI of nCells (not CGI, PLMNs etc)=yes/no;
   frequencies on which nCell detection shall be performed; and
   PLMNs for which nCells shall be logged.

### Group C Embodiments

45. A wireless device for improving network efficiency, the wireless device comprising:
   processing circuitry configured to perform any of the steps of any of the Group A embodiments; and
   power supply circuitry configured to supply power to the wireless device.
46. A base station for improving network efficiency, the base station comprising:
   processing circuitry configured to perform any of the steps of any of the Group B embodiments;
   power supply circuitry configured to supply power to the wireless device.
47. A user equipment (UE) for improving network efficiency, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
48. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
49. The communication system of the pervious embodiment further including the base station.
50. The communication system of the previous 2 embodiments, further including the UE, wherein the UE is configured to communicate with the base station.
51. The communication system of the previous 3 embodiments, wherein:
   the processing circuitry of the host computer is configured to execute a host application, thereby providing the user data; and
   the UE comprises processing circuitry configured to execute a client application associated with the host application.
52. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
53. The method of the previous embodiment, further comprising, at the base station, transmitting the user data.
54. The method of the previous 2 embodiments, wherein the user data is provided at the host computer by executing a host application, the method further comprising, at the UE, executing a client application associated with the host application.
55. A user equipment (UE) configured to communicate with a base station, the UE comprising a radio interface and processing circuitry configured to performs the of the previous 3 embodiments.
56. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
57. The communication system of the previous embodiment, wherein the cellular network further includes a base station configured to communicate with the UE.
58. The communication system of the previous 2 embodiments, wherein:
   the processing circuitry of the host computer is configured to execute a host application, thereby providing the user data; and
   the UE's processing circuitry is configured to execute a client application associated with the host application.
59. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
60. The method of the previous embodiment, further comprising at the UE, receiving the user data from the base station.
61. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
62. The communication system of the previous embodiment, further including the UE.
63. The communication system of the previous 2 embodiments, further including the base station, wherein the base station comprises a radio interface configured to communicate with the UE and a communication interface configured to forward to the host computer the user data carried by a transmission from the UE to the base station.
64. The communication system of the previous 3 embodiments, wherein:
   the processing circuitry of the host computer is configured to execute a host application; and
   the UE's processing circuitry is configured to execute a client application associated with the host application, thereby providing the user data.
65. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
66. A method implemented in a communication system including a host computer, a base station and a user equipment (UE), the method comprising:
   at the host computer, receiving user data transmitted to the base station from the UE, wherein the UE performs any of the steps of any of the Group A embodiments.
67. The method of the previous embodiment, further comprising, at the UE, providing the user data to the base station.
68. The method of the previous 2 embodiments, further comprising:
   at the UE, executing a client application, thereby providing the user data to be transmitted; and
   at the host computer, executing a host application associated with the client application.
69. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
70. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
71. The communication system of the previous embodiment further including the base station.
72. The communication system of the previous 2 embodiments, further including the UE, wherein the UE is configured to communicate with the base station.
73. The communication system of the previous 3 embodiments, wherein:
   the processing circuitry of the host computer is configured to execute a host application;
   the UE is configured to execute a client application associated with the host application, thereby providing the user data to be received by the host computer.
74. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
75. The method of the previous embodiment, further comprising at the base station, receiving the user data from the UE.
76. The method of the previous 2 embodiments, further comprising at the base station, initiating a transmission of the received user data to the host computer.

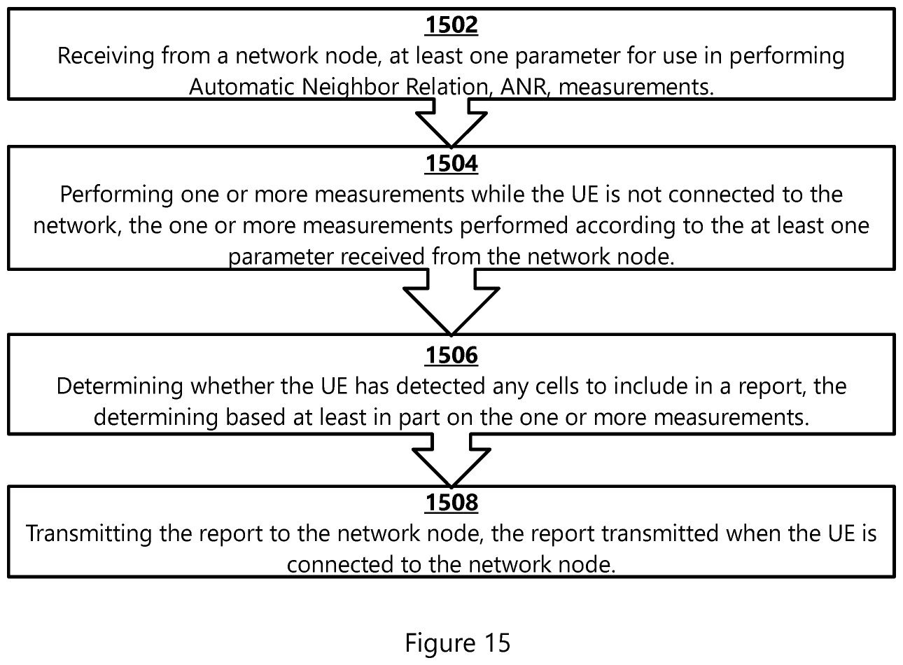

FIG. 15 illustrates an example of a method performed by a UE, such as wireless device 110 or UE 200 described above, in accordance with certain embodiments.

At step 1502, the method receives, from a network node, at least one parameter for use in performing ANR measurements. In certain embodiments, the at least one parameter is received from the network node via RRC signaling. Examples of parameters for use in performing ANR measurements may include one or more of: an absolute threshold for a neighboring cell (nCell); a relative threshold for nCell compared to the serving/camped cell; an additional offset for nCell relative cell reselection thresholds; a number of detections of an nCell meeting the threshold; a time period when nCell detection shall be performed; special DRX cycles to use when the nCell measurements are performed; a minimum time period for detection of an nCell meeting the threshold; a minimum time to keep the nCells in a log; a minimum number of nCells to keep in the log, once detected; a latest time when the UE shall report the log to the network node; time between measurements for nCells; a value indicating whether nCell measurements shall only be performed when the UE is out of PSM because of a reason other than performing said measurements; a value indicating whether nCell measurements shall only be performed when the UE is out of DRX sleep because of a reason other than performing said measurements; a whitelist of PCIs which are the only ones that shall be logged; a blacklist of PCIs that shall not be logged; a value indicating to only log PCI of nCells; frequencies on which nCell detection shall be performed; and Public Land Mobile Networks, PLMNs, for which nCells shall be logged.

At step 1504, the method performs one or more measurements while the UE is not connected to the network, such as when the UE is in idle mode or another unconnected mode. In certain embodiments, the measurements may be performed when the UE is out of power saving mode. The one or more measurements are performed according to the at least one parameter received from the network node in step 1502. For example, in certain embodiments, the at least one parameter comprises a time between measurements for nCells. Thus, certain embodiments perform the measurements according to the time between measurements for nCells parameter.

The method proceeds to step 1506 with determining, based at least in part on the one or more measurements performed in step 1504, whether the UE has detected any cells to include in a report. In certain embodiments, the report may indicate ANR results. For example, the report may comprise a CGI report, an ANR log, or a neighbor cell log. In certain embodiments, the report indicates one or more cells that have been detected by the UE and meet certain criteria, for example, to confirm that the detected cell qualifies as a strong cell.

Certain embodiments determine that a cell detected by the UE is a strong cell when at least one measurement value from the cell exceeds a threshold. As an example, certain embodiments determine that a cell detected by the UE is a strong cell when at least one RSRP measurement value from the cell exceeds an RSRP threshold (which may correspond to an absolute RSRP level in certain embodiments). As another example, certain embodiments determine that a cell detected by the UE is a strong cell when at least one RSRQ measurement value from the cell exceeds an RSRQ threshold. As another example, certain embodiments determine that a cell detected by the UE is a strong cell when at least one SINR measurement value from the cell exceeds an SINR threshold.

In certain embodiments, the at least one measurement is performed for a measurement period duration, and the at least one measurement value must exceed the threshold for at least the measurement period duration in order for the cell detected by the UE to be considered a strong cell. In certain embodiments, the at least one parameter comprises a minimum time period for detection of an nCell meeting a threshold. Thus, certain embodiments determine to include a detected cell in the report based at least in part on a measurement value associated with the detected cell meeting the threshold for at least the minimum time period for detection of the nCell.

Certain embodiments may consider other criteria when determining whether to include a cell in the report. For example, certain embodiments may verify that a cell is on a white list, or is not on a black list, before including the cell in the report.

In certain embodiments, the method determines that the report is to be empty if the UE has not detected any cells to include in the report. This can occur when measurement values associated with the detected cells fail to exceed the threshold (or fail to exceed the threshold for a sufficient amount of time), when the detected cells are on a black list (or are not on a white list), when the detected cells otherwise fail to meet criteria for being included in the report, and/or when no cells are detected.

At step 1508, the method transmits the report to the network node when the UE is connected to the network node. In certain embodiments, the method transmits the report to the network node when the UE is connected to the network anyway for purposes other than for transmitting the report. That is, the UE will not transition from idle mode (or other unconnected mode) to connected mode only for the purpose of transmitting the report; however, if the UE has any other reasons for transitioning to connected mode, for example, in order to send uplink data, then the UE can send the report while in connected mode. As an example, in certain embodiments, the UE in connected mode may indicate to the network that the report is available and the network may decide whether to fetch the result or not.

In certain embodiments, the at least one parameter received in step 1502 comprises a latest time when the UE shall report a log to the network node. Thus, in certain embodiments, the report transmitted to the network node in step 1508 is transmitted by the latest time when the UE shall report the log to the network node.

As discussed above, certain embodiments include a CGI for the strong cell in the report. Certain embodiments obtain the CGI for the strong cell autonomously. Certain embodiments obtain the CGI for the strong cell in response to determining that a PCI of the strong cell is not included on a black list (the black list indicates cells that are not of interest to the network node). Certain embodiments store the CGI of the strong cell for a predetermined amount of time. The predetermined amount of time comprises one or more DRX or eDRX cycles for cell reselection. After detecting the strong cell, certain embodiments switch from an e-DRX cycle to a DRX cycle. The DRX cycle is shorter than the e-DRX cycle, and the CGI is obtained while the wireless device is in the DRX cycle.

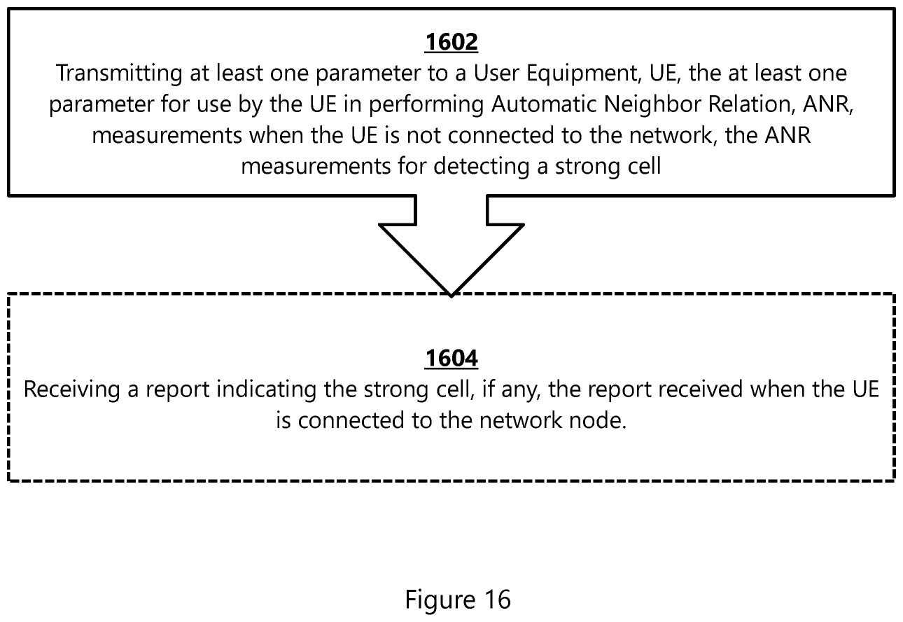

FIG. 16 illustrates an example of a method performed by a network node, such as network node 160, in accordance with certain embodiments. In certain embodiments, the method of FIG. 16 may be performed by a network node in communication with a UE performing the method of FIG. 15. Thus, the discussion of FIG. 15 provides context for FIG. 16, and vice versa.

At step 1602, the method comprises transmitting at least one parameter to a UE. The at least one parameter is for use by the UE in performing ANR measurements when the UE is not connected to the network, the ANR measurements for detecting a strong cell.

In certain embodiments, the at least one parameter is transmitted to the UE via RRC signaling. Examples of parameters for use in performing ANR measurements may include one or more of: an absolute threshold for a neighboring cell (nCell); a relative threshold for nCell compared to the serving/camped cell; an additional offset for nCell relative cell reselection thresholds; a number of detections of an nCell meeting the threshold; a time period when nCell detection shall be performed; special DRX cycles to use when the nCell measurements are performed; a minimum time period for detection of an nCell meeting the threshold; a minimum time to keep the nCells in a log; a minimum number of nCells to keep in the log, once detected; a latest time when the UE shall report the log to the network node; time between measurements for nCells; a value indicating whether nCell measurements shall only be performed when the UE is out of PSM because of a reason other than performing said measurements; a value indicating whether nCell measurements shall only be performed when the UE is out of DRX sleep because of a reason other than performing said measurements; a whitelist of PCIs which are the only ones that shall be logged; a blacklist of PCIs that shall not be logged; a value indicating to only log PCI of nCells; frequencies on which nCell detection shall be performed; and Public Land Mobile Networks, PLMNs, for which nCells shall be logged.

In certain embodiments, the method may further comprise configuring the UE in a certain manner. In general, configuring a UE may comprise determining configuration information for the UE and transmitting the configuration information to the UE. Depending on the embodiment, the configuration information may correspond to one or more parameters transmitted in step 1602 and/or other configuration information transmitted to the UE.

In certain embodiments, the method comprises configuring the UE to detect a PCI of a strong cell in response to performing at least one measurement and determining that at least one measurement value associated with the measurement exceeds a threshold. As discussed above, the measurement value may be an RSRP measurement value, an RSRQ measurement value, or an SINR. In certain embodiments, the method comprises configuring the UE to perform the at least one measurement for a measurement period duration and detect the PCI of the strong cell in response to the at least one measurement value exceeding the threshold for the measurement period duration.

In certain embodiments, the method comprises configuring the UE to obtain a CGI autonomously.

In certain embodiments, the method comprises configuring the UE to obtain the CGI for the strong cell in response to determining that the PCI of the strong cell is not included on a black list that the network node transmits to the UE. The black list indicates cells that are not of interest to the network node.

In certain embodiments, the method comprises configuring the UE to store the CGI of the strong cell for a predetermined amount of time. The predetermined amount of time comprises one or more DRX or eDRX cycles for cell reselection.

In certain embodiments, the method comprises configuring the UE to, after detecting the PCI of the strong cell, switch from an e-DRX cycle to a DRX cycle, wherein the DRX cycle is shorter than the e-DRX cycle, and wherein the CGI is obtained while the wireless device is in the DRX cycle.

In certain embodiments, the method comprises configuring the UE with a minimum time period for detection of an nCell meeting a threshold.

In certain embodiments, the method comprises configuring the UE with a latest time when the UE shall report a log to the network node.

In certain embodiments, the method comprises configuring the UE with a time between measurements for nCells.

Certain embodiments include step 1604, wherein the method comprises receiving a report from the UE. The report indicates to the network node whether the UE has detected any cells to include in a report. In certain embodiments, the report may indicate ANR results. For example, the report may comprise a CGI report, an ANR log, or a neighbor cell log. In certain embodiments, the report indicates one or more cells that have been detected by the UE and meet certain criteria, for example, to confirm that the detected cell qualifies as a strong cell. In certain embodiments, the report received from the UE is empty. An empty report may indicate that the UE did not detect any cells that qualify as a strong cell. Depending on the embodiment, this may occur when the RSRP, RSRQ, or SINR measurement values are not strong enough (or are not strong enough for a sufficient amount of time), when the detected cells are on a black list (or are not on a white list), or when the UE otherwise does not detect any cells that qualify as a strong cell.

Certain embodiments receive the report of step 1604 when the UE is connected to the network node. In certain embodiments, the method receives the report when the UE is connected to the network anyway for purposes other than for transmitting the report. That is, the UE will not transition from idle mode (or other unconnected mode) to connected mode only for the purpose of transmitting the report; however, if the UE has any other reasons for transitioning to connected mode, for example, in order to send uplink data, then the UE can send the report while in connected mode. As an example, in certain embodiments, the UE in connected mode may indicate to the network that the report is available and the network may decide whether to fetch the result or not.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1.-66. (canceled)

67. A method performed by a User Equipment, UE, which is configured with a long Discontinuous Reception, e-DRX, cycle, the method comprising:
receiving, from a network node, at least one parameter for use in performing Automatic Neighbor Relation, ANR, measurements;
performing one or more measurements while the UE is not connected to the network, the one or more measurements performed according to the at least one parameter received from the network node;
determining that a cell detected by the UE is a strong cell when at least one measurement value from the cell exceeds a threshold;
after detecting the strong cell, switching from the e-DRX cycle configuration to a normal DRX cycle configuration, wherein the normal DRX cycle is shorter than the e-DRX cycle and obtaining the Cell Group Identifier, CGI, for the strong cell while the UE (110) is in the normal DRX cycle;
determining whether the UE has detected any cells to include in a report, the determining based at least in part on the one or more measurements;
transmitting the report to the network node, the report transmitted when the UE is connected to the network node; and
after transmission of the report to the network node, switching back to the e-DRX cycle configuration.

68. The method of claim 67, wherein the at least one measurement is performed for a measurement period duration, and the at least one measurement value exceeds the threshold for the measurement period duration.

69. The method of claim 67, wherein the measurement value is a reference signal received power, RSRP, measurement value, a reference signal received quality, RSRQ, measurement value, or a signal-to-interference-plus-noise ratio, SINR.

70. The method of claim 67, wherein the threshold comprises an absolute RSRP level.

71. The method of claim 67, further comprising:
including a cell global identity, CGI, for the strong cell in the report.

72. The method of claim 67, further comprising obtaining the CGI for the strong cell autonomously.

73. The method of claim 67, further comprising obtaining the CGI for the strong cell in response to determining that a Physical Cell Identity, PCI, of the strong cell is not included on a black list, the black list indicating cells that are not of interest to the network node.

74. The method of claim 67, further comprising storing the CGI of the strong cell for a predetermined amount of time, wherein the predetermined amount of time comprises one or more Discontinuous Reception, DRX, or Extended Discontinuous Reception, eDRX, cycles for cell reselection.

75. The method of claim 67, wherein the at least one parameter is received from the network node via Radio Resource Control, RRC, signaling.

76. The method of claim 67, wherein the at least one parameter comprises any one or more of:
an absolute threshold for a neighboring cell (nCell);
a relative threshold for nCell compared to the serving/camped cell;
an additional offset for nCell relative cell reselection thresholds;
a number of detections of an nCell meeting the threshold;
a time period when nCell detection shall be performed;
special DRX cycles to use when the nCell measurements are performed;
a minimum time period for detection of an nCell meeting the threshold;
a minimum time to keep the nCells in a log;
a minimum number of nCells to keep in the log, once detected;
a latest time when the UE (110) shall report the log to the network node;
time between measurements for nCells;
a value indicating whether nCell measurements shall only be performed when the UE is out of Power Saving Mode, PSM, because of a reason other than performing said measurements;
a value indicating whether nCell measurements shall only be performed when the UE is out of DRX sleep because of a reason other than performing said measurements;
a whitelist of PCIs which are the only ones that shall be logged;
a blacklist of PCIs that shall not be logged;
a value indicating to only log PCI of nCells;
frequencies on which nCell detection shall be performed; and
Public Land Mobile Networks, PLMNs, for which nCells shall be logged.

77. A User Equipment, UE, the UE is configured with a long Discontinuous Reception, e-DRX, cycle, comprising:
power supply circuitry configured to supply power to the UE; and
processing circuitry configured to:
receive, from a network node, at least one parameter for use in performing Automatic Neighbor Relation, ANR, measurements;
perform one or more measurements while the UE is not connected to the network, the one or more measurements performed according to the at least one parameter received from the network node;
determine that a cell detected by the UE is a strong cell when at least one measurement value from the cell exceeds a threshold;
after detecting the strong cell, switch from the e-DRX cycle configuration to a normal DRX cycle configuration, wherein the normal DRX cycle is shorter than the e-DRX cycle and obtain the Cell Group Identifier, CGI, for the strong cell while the UE is in the normal DRX cycle;
determine whether the UE has detected any cells to include in a report, the determining based at least in part on the one or more measurements;
transmit the report to the network node, the report transmitted when the UE is connected to the network node; and
after transmission of the report to the network node, switch back to the e-DRX cycle configuration.

78. The UE of claim 77, wherein the at least one measurement is performed for a measurement period duration, and the at least one measurement value exceeds the threshold for the measurement period duration.

79. The UE of claim 77, wherein the measurement value is a reference signal received power, RSRP, measurement value, a reference signal received quality, RSRQ, measurement value, or a signal-to-interference-plus-noise ratio, SINR.

80. The UE of claim 77, wherein the threshold comprises an absolute RSRP level.

81. The UE of claim 77, the processing circuitry further configured to include
a cell global identity, CGI, for the strong cell in the report.

82. The UE of claim 77, the processing circuitry further configured to obtain the CGI for the strong cell autonomously.

83. The UE of claim 77, the processing circuitry further configured to obtain the CGI for the strong cell in response to determining that a Physical Cell Identity, PCI, of the strong cell is not included on a black list, the black list indicating cells that are not of interest to the network node.

84. The UE of claim 77, the processing circuitry further configured to store the CGI of the strong cell for a predetermined amount of time, wherein the predetermined amount of time comprises one or more Discontinuous Reception, DRX, or Extended Discontinuous Reception, eDRX, cycles for cell reselection.

85. The UE of claim 77, wherein the at least one parameter is received from the network node via Radio Resource Control, RRC, signaling.

86. The UE of claim 77, wherein the at least one parameter comprises any one or more of:
an absolute threshold for a neighboring cell (nCell);
a relative threshold for nCell compared to the serving/camped cell;
an additional offset for nCell relative cell reselection thresholds;
a number of detections of an nCell meeting the threshold;
a time period when nCell detection shall be performed;
special DRX cycles to use when the nCell measurements are performed;
a minimum time period for detection of an nCell meeting the threshold;
a minimum time to keep the nCells in a log;
a minimum number of nCells to keep in the log, once detected;
a latest time when the UE (110) shall report the log to the network node;
time between measurements for nCells;
a value indicating whether nCell measurements shall only be performed when the UE is out of Power Saving Mode, PSM, because of a reason other than performing said measurements;
a value indicating whether nCell measurements shall only be performed when the UE is out of DRX sleep because of a reason other than performing said measurements;
a whitelist of PCIs which are the only ones that shall be logged;
a blacklist of PCIs that shall not be logged;
a value indicating to only log PCI of nCells;
frequencies on which nCell detection shall be performed; and
Public Land Mobile Networks, PLMNs, for which nCells shall be logged.
